(19) United States
(12) Patent Application Publication
(10) Pub. No.: US 2019/0323991 A1
(43) Pub. Date: Oct. 24, 2019

(54) METHOD FOR MEASURING BY EDDY CURRENTS AND DEVICE FOR MEASURING BY EDDY CURRENTS

(71) Applicant: COMMISSARIAT A L'ENERGIE ATOMIQUE ET AUX ENERGIES ALTERNATIVES, Paris (FR)

(72) Inventors: Frederic NOZAIS, Montigny-le-Bretonneux (FR); Jean-Marc DECITRE, Marcoussis (FR)

(73) Assignee: COMMISSARIAT A L'ENERGIE ATOMIQUE ET AUX ENERGIES ALTERNATIVES, Paris (FR)

(21) Appl. No.: 16/312,636

(22) PCT Filed: Jun. 26, 2017
(86) PCT No.: PCT/FR2017/051699

§ 371 Date: Dec. 21, 2018

(30) Foreign Application Priority Data
Jun. 27, 2016 (FR) 16 55948

(51) Int. Cl. G01N 27/90

(52) U.S. Cl. CPC G01N 27/904; H01F 27/24; G01N 27/9033

(57) ABSTRACT

A method for measuring by eddy currents, including: a) providing at least one magnetic field sensor; b) providing at least one first magnetic inductor for generating a first magnetic field which, at the magnetic field sensor, is orientated in a first direction of the detection axis; c) providing at least one second magnetic inductor configured to generate a second magnetic field which, at the magnetic field sensor, is orientated in a second direction of the detection axis; d) providing a current supply system; e) modifying configuration of the first and second magnetic inductors with respect to the magnetic field sensor and/or the current supply system such that the sum of the first and second magnetic fields at the magnetic field sensor is zero; and f) measuring the eddy currents of a sample.

### TECHNICAL FIELD

The invention relates to the field of non-destructive measurements and more particularly relates to non-destructive measurements by eddy currents.

The object of the invention is therefore a method for measuring by eddy currents and a device for measuring by eddy currents.

### STATE OF THE PRIOR ART

The use of measurements by eddy currents allows the detection of any defects on the surface of a metal object, over a depth of 10 to 15 mm. It is therefore possible to perform non-destructive detection of any cuts, cracks or other traces of corrosion on metal objects that are not necessarily planar. These types of measurements are particularly employed in the aeronautics industry to inspect structural parts of an aircraft i.e. the fuselage and wings.

A measuring method, with reference to FIG. 1, generally comprises the following steps:

A) providing at least one magnetic field sensor 110 having a detection axis 111 along which the magnetic field sensor 110 is sensitive to the magnetic field,

B) providing at least one first magnetic inductor 120 configured to generate a magnetic field B1 at a measurement zone 210,

D) providing a current supply system 140 to apply to the first magnetic inductor 120 a first periodic current I1 having a given period,

F) non-destructive measurement by eddy currents of a given sample 200, the measurement zone 210 comprising at least one surface portion 201 of said sample 200.

It will evidently be noted, in accordance with the principle of measurement by eddy currents, that while at step F) the measurement zone 210 comprises at least one surface portion 201 of the sample, this measurement zone 210 extends beyond the surface 201 and includes part of the sample lying below the surface 201 of the sample 200. Therefore, such a measurement by eddy currents allows detection of some of the embedded defects.

At measurement step F), the current supply system 140 applies the first periodic current I1 to the first magnetic inductor 120 to generate a periodic magnetic field at the measurement zone 210. This periodic magnetic field generates an electrical current in the sample and in the vicinity of its surface, called an eddy current, which in turn generates a magnetic field at the magnetic field sensor 110. The slightest defect, by perturbing the path of the eddy currents, leads to a variation in the magnetic field perceived by the magnetic field sensor 110.

To optimize measurement of the magnetic field generated by eddy currents, perceived by the magnetic field sensor 110, and to facilitate analysis of measurements by eddy currents, it is known to use the configuration of the first magnetic inductor 120 illustrated in FIG. 1. With this configuration, the first magnetic inductor 120 under a given current condition generates a magnetic field B1 which, at the magnetic field sensor 110 is oriented along a first direction of the detection axis 111, and at a measurement zone 210 is oriented along a second direction of the detection axis 111 opposite the first direction of the detection axis 111.

It is seen that with such a configuration, the magnetic field generated by the eddy currents is directed along the detection axis 111. The variation in measurement by eddy currents is thereby reinforced. In addition, this variation for a defect in such a configuration is in a simple form called monopolar i.e. close to a Dirac distribution. Detection is therefore simplified and it is easy to interpret measurements by eddy currents to determine the location and even the size of the identified defects.

While this configuration is particularly optimized to perform measurement by eddy currents, it has major drawbacks. In such a configuration, the magnetic field sensor along its detection axis 111 is subjected to the sum of the magnetic fields generated by the first magnetic inductor 120 and the field generated by the eddy currents. Yet the sensitivity of a magnetic field sensor 110, irrespective of type, is generally limited and in this configuration the magnetic field sensor 110 is chiefly employed to measure a known magnetic field, the field generated by the first magnetic inductor 120. Moreover, in such a configuration, the intensity of the current powering the first magnetic inductor 120 must be limited so that the magnetic field it induces does not saturate the magnetic field sensor 110. Therefore, the generated eddy currents and hence the measured signal are thereby limited.

To overcome these disadvantages, it is known from document WO2015/177341 to arrange this first magnetic inductor 120 in a configuration in which it generates a magnetic field perpendicular to the detection axis 111. In this manner, the magnetic field generated by the first magnetic inductor 120 is not detected by the magnetic field sensor and does not perturb measurement of the magnetic field generated by the eddy currents.

Nevertheless, as previously indicated, such a configuration is not optimized to provide a magnetic field generated by eddy currents along the detection axis, and measurements by eddy currents are thereby made more difficult to interpret.

It is noted that it is also known from document WO2015/177341 to provide a second magnetic inductor to facilitate adjustment of the magnetic field at the detection axis and hence obtain, at the magnetic field sensor, a sum of the magnetic fields generated by the first and second magnetic inductor that is substantially perpendicular to the detection axis. This possibility has the same above-mentioned disadvantages as the configuration in document WO2015/177341 only employing a single magnetic inductor.

In the prior art, there are therefore no method for measuring by eddy currents allowing optimized sensitivity of measurement of the magnetic field generated by eddy currents, and which have a configuration facilitating interpretation of measurement by eddy currents.

### DISCLOSURE OF THE INVENTION

The invention sets out to solve this disadvantage and therefore has the objective of providing a method for measuring by eddy currents allowing optimized sensitivity of measurement of the magnetic field generated by eddy currents whilst facilitating interpretation of the measurements obtained.

For this purpose, the invention relates to a method for measuring by eddy currents comprising the following steps:

A) providing at least one magnetic field sensor having a detection axis along which the magnetic field sensor is sensitive to the magnetic field,

B) providing at least one first magnetic inductor configured to generate under a given current condition a first magnetic field which, at the magnetic field sensor is oriented along a first direction of the detection axis, and at a measurement zone is oriented along a second direction of the detection axis opposite the first direction of the detection axis,

D) providing a current supply system to apply to the first magnetic inductor a first periodic current having a given period.

The method further comprising the following steps:

C) providing at least one second magnetic inductor configured to generate, under the same given current condition as for the first magnetic inductor, a second magnetic field at the magnetic field sensor which, at the magnetic field sensor and at the measurement zone is oriented along the second direction of the detection axis,

the current supply system provided at step D) also being configured to apply to the second magnetic inductor a second periodic current having the given period,

E) modifying the configuration of the first and second magnetic inductor in relation to the magnetic field sensor and/or to the current supply system so that, on application of the first and second current, the sum of the first and second magnetic field at the magnetic field sensor is substantially zero,

F) performing non-destructive measurement by eddy currents of a given sample, the sample being positioned so that the measurement zone comprises at least one surface portion of said sample, the configuration of the first and second magnetic inductor modified at step E) being maintained throughout measurement.

By “sum of the first and second magnetic field at the magnetic field sensor” it is to be understood, above and in the remainder of this document, the vector sum of the first and second magnetic field at the magnetic sensor. Therefore, with such a substantially zero sum, the first and the second magnetic field at the magnetic field sensor each along the detection axis in opposite direction to each other are of substantially equal amplitude. In general, when mention is made of the sum of magnetic fields this sum is a vector sum unless otherwise indicated.

Similarly, since the measuring method of the invention remains a method for measuring by eddy currents, the measurement zone comprising at least one surface portion of the sample, the measurement zone evidently extends beyond the surface and includes a portion of the sample lying under the surface of the sample. Therefore, such a method for measuring by eddy currents of the invention also allows detection of some of the embedded defects.

Such a method for measuring by eddy currents allows a reduction, at the magnetic field sensor, in the relative share of the magnetic field generated by the magnetic inductor(s) in relation to the magnetic field generated by the eddy currents. The use of the second inductor combined with modification of the configuration of the first and second magnetic inductor, allows at least partial offsetting of the magnetic field generated by the first magnetic inductor, by the magnetic field generated by the second inductor. This offsetting is accompanied by reinforcing of the magnetic field generated at the measurement zone, the magnetic fields generated by the first and second magnetic inductor constructively adding together thereat. The resulting eddy currents at the measurement zone are therefore themselves reinforced.

In addition, this field sum being oriented at the measurement zone along the detection axis of the magnetic field sensor, this means that the magnetic field generated by the eddy currents at the measurement zone is also oriented along the detection axis. The detection of the magnetic field generated by eddy currents is therefore optimized and interpretation of measurements by eddy currents is thereby facilitated.

With such a measuring method, it therefore follows that the sum of the magnetic fields induced by the first and second magnetic inductor at the magnetic field sensor is low, even zero, whereas the magnetic field generated by the eddy currents is particularly optimized whilst allowing easy interpretation of measurements.

It will be noted that such a method is beneficial irrespective of the type of magnetic field sensor provided at step A). If the magnetic field sensor is a sensor of inductive type i.e. based on a coil, only the wanted signal i.e. the magnetic field generated by the eddy currents and more particularly by modification of these eddy currents in the presence of a defect, is amplified. First, amplification of the signal from the coil can be increased without risking saturation of the amplification stage, and secondly it is possible to increase the currents in the inductors. The signal-to-noise ratio is improved further to one and/or the other of these actions. If the magnetic field sensor is a sensor of magnetic type i.e. a sensor using a physical principle such as magnetoresistance, giant magnetoresistance, giant magnetoimpedance or the Hall effect, the sensitivity of the magnetic field sensor is essentially used for the wanted signal i.e. the magnetic field generated by the eddy currents. It is therefore possible to use the entire sensitivity range of the magnetic field sensor whilst limiting risks of saturation related to magnetic fields induced by the magnetic inductors.

Step E) for modifying the configuration of the first and second magnetic inductor can be performed at least partly in the absence of the sample.

With such a step E) for modifying the configuration of the first and second magnetic inductor, it is possible to obtain measurement by eddy currents that is relatively sensitive irrespective of sample. While it is possible that the sample, on account of the airgap effect (defined in this document as being the distance between an inductor and the sample) may modify the sum of the first and second magnetic fields at the magnetic field sensor, this modification will remain contained. The sum of the first and second magnetic field at the magnetic field sensor remains contained, and the relatively optimized sensitivity compared with prior art methods remains irrespective of type of sample.

Step E) for modifying the configuration of the first and second magnetic inductor can be performed at least partly in the presence of the sample with at least one surface portion of the sample merging with the measurement zone, the measurement zone remaining on the surface of the sample when implementing step F).

With such a step E) for modifying the configuration of the first and second magnetic inductor, measurement by eddy currents is particularly optimized. The presence of the sample at step E) allows correction of the airgap effect that may be created. Therefore, at measuring step F), the sum of the first and of second magnetic fields at the magnetic field sensor is substantially zero and therefore scarcely affects, even does not affect, the sensitivity of measurement by eddy currents.

At step D) for providing the second magnetic inductor, the second magnetic inductor can be substantially identical to the first magnetic inductor.

Step E) for modifying the configuration of the first and second magnetic inductor may comprise the following sub-steps:
E1) configuring the current supply system so that the first and second periodic current are substantially identical,
E2) modifying the relative positioning of the second magnetic inductor so that it is positioned symmetrically with the first magnetic inductor relative to the detection axis.

The combination of the use of a first and second inductor that are substantially identical and the positioning of the first and second inductor symmetrically with one another relative to the detection axis allows simple obtaining of a sum of the first and second magnetic fields, by applying identical first and second currents, that is substantially zero at the magnetic field sensor.

Step E) for modifying the configuration of the first and second magnetic inductor may comprise the following sub-steps:
E′1) configuring the current supply system to apply the first and second periodic current,
E′2) moving the second magnetic inductor so as to cancel the sum of the first and second magnetic field at the magnetic field sensor.

Step E) for modifying the configuration of the first and second magnetic inductor may comprise the following sub-steps:
E″1) configuring the current supply system to apply the first and second periodic current,
E″2) moving the magnetic field sensor in relation to the first and the second magnetic inductor so as to cancel the sum of the first and second magnetic field at the magnetic field sensor.

Such steps for modifying the configuration of the first and second magnetic inductor, by a simple modification of the relative positioning of one from among the second magnetic inductor and the magnetic field sensor, allow cancelling of the sum of the first and second magnetic field at the magnetic field sensor.

Step E) for modifying the configuration of the first and second magnetic inductor may comprise the following sub-steps:
E3) configuring the current supply system to apply the first and second periodic current,
E4) modifying the second periodic current so as to cancel the sum of the first and second magnetic field at the magnetic field sensor.

With such a step for modifying the first and second magnetic inductor, the cancelling of the sum of the first and second magnetic field at the magnetic field sensor can be obtained by simple configuration of the current supply system.

The invention also relates to a device for measuring by eddy currents, the measuring device comprising:
at least one magnetic field sensor having a detection axis along which the magnetic field sensor is sensitive to the magnetic field,
at least one first magnetic inductor configured to generate under a given current condition a first magnetic field which, at the magnetic field sensor is oriented along a first direction of the detection axis, and at a measurement zone is oriented along a second direction of the detection axis opposite the first direction of the detection axis,
at least one current supply system to apply to the first a first periodic current having a given period,
the measuring device also comprising at least one second magnetic inductor configured to generate, under the same current conditions as for the first magnetic inductor, a second magnetic field which at the magnetic field sensor and at the measurement zone is oriented along the second direction of the detection axis,
the current supply system being configured to apply to the second magnetic inductor a second periodic current having the given period,
and wherein the first and second magnetic inductor have at least one configuration in relation to the magnetic field sensor and to the current supply system so that, on application of the first and second current, the sum of the magnetic field respectively induced by the first and second magnetic inductor at the magnetic field sensor is substantially zero.

Such a device allows implementation of a measuring method according to the invention and thereby benefits from the advantages related to this same measuring method.

The first and second magnetic inductor can be substantially identical.

The current supply system can be configured to supply the first and second inductor with a substantially identical first and second current.

These configurations of the first and second magnetic inductor and of the current supply system allow easy cancelling of the sum of the first and second magnetic field at the magnetic field sensor.

The second magnetic inductor can be movably mounted in relation to the first magnetic inductor and to the magnetic field sensor.

In this manner, the cancelling of the sum of the first and second magnetic field at the magnetic field sensor can be obtained by moving the second magnetic inductor in relation to the first magnetic inductor and to the magnetic field sensor.

The magnetic field sensor can be movably mounted in relation to the first and second magnetic inductor.

In this manner, the cancelling of the sum of the first and second magnetic field at the magnetic field sensor can be obtained by moving the magnetic field sensor relative to the first and second magnetic inductor.

The current supply system can be configured to apply a second periodic current to the second magnetic inductor differing from the first periodic current, to allow the configuration of the first and second magnetic inductor to be obtained in relation to the magnetic field sensor and current supply system, in which on application of the first and second periodic current the sum of the magnetic field respectively induced by the first and second magnetic inductor at the magnetic field sensor is substantially zero.

In this manner, the cancelling of the sum of the first and second magnetic field at the magnetic field sensor can be obtained by adjusting the second current in relation to the first current.

The first and second magnetic inductor are respectively provided by a first and second coil respectively formed on the first and second side of a flexible dielectric support,

and wherein the magnetic field sensor is included in the flexible dielectric support.

Such a flexible dielectric support enables to the device of the invention to follow the contour of the surface of the sample to be measured.

### BRIEF DESCRIPTION OF THE DRAWINGS

The present invention will be better understood on reading the description of examples of embodiment given solely for indication purposes and in no way limiting, with reference to the appended drawings in which:

FIG. 1 is a schematic view of a device for measuring by eddy currents in the prior art which allows simplified detection of defects,

FIG. 2 is a schematic view of a device for measuring by eddy currents according to a first embodiment of the invention,

FIG. 3 is a flowchart of the main steps of a method for measuring by eddy currents of the invention,

FIGS. 4A and 4B respectively illustrate a measuring device according to a second embodiment wherein the first and second magnetic inductor are provided as two ribbons, and a configuration of this same measuring device illustrating the positioning of the first magnetic inductor in relation to a sample having a defect, to simulate measurement by eddy currents,

FIGS. 5A to 5C place in parallel the variation in magnetic field simulated in the configuration of FIGS. 4A and 4B for a device for measuring by eddy currents according to the prior art only comprising a single magnetic inductor, and that simulated by a device for measuring by eddy currents according to the invention with a graph in FIG. 5A showing the magnetic field measured in the complex plane along the sample, a graph in FIG. 5B showing the variation in amplitude of the magnetic field measured along the sample, and a graph in FIG. 5C showing the variation in magnetic field measured in the complex plane along the sample,

FIG. 6 illustrates an arrangement of two magnetic field sensors, of two first inductors and of a second magnetic inductor according to a third embodiment of the invention,

FIG. 7 illustrates an arrangement of a plurality of magnetic field sensors associated with a first and with two second magnetic inductors according to a fourth embodiment of the invention.

### DETAILED DESCRIPTION OF PARTICULAR EMBODIMENTS

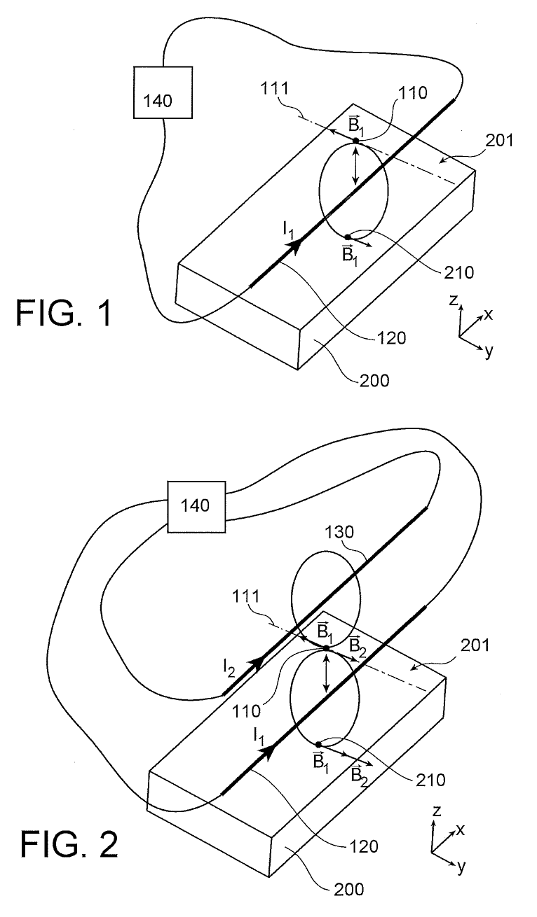

FIG. 2 illustrates a device for measuring by eddy currents 100 according to the invention when used for measurement by eddy currents on a sample 200.

Such a measuring device comprises:
a magnetic field sensor 110 having a detection axis 111 along which the magnetic field sensor 110 is sensitive to the magnetic field,
a first magnetic inductor 120 configured to generate under a given current condition a first magnetic field B1 which, at the magnetic field sensor 110 is oriented along a first direction of the detection axis 111, and at a measurement zone 210 is oriented along a second direction of the detection axis 111 opposite the first direction of the detection axis 111,
a second magnetic inductor 130 configured to generate, under the same conditions as for the first magnetic inductor 120, a second magnetic field B2 which at the magnetic field sensor 110 and at the measurement zone 210 is oriented along the second direction of the detection axis 210,
a current supply system 140 to apply to the first and to the second magnetic inductor 120, 130 respectively a first and a second periodic current I1, I2 having a given period.

The first magnetic field sensor 110 is illustrated in FIG. 2 solely as its detection axis 111. The first magnetic field sensor can be any type of magnetic field sensor adapted to detect the magnetic field generated by eddy currents at the time of measurement. Therefore, the first magnetic field sensor 110 can be either of inductive type such as conventional coil or flat coil on a flexible support, or of magnetic type such as such as sensors based on magnetoresistance, sensors based on giant magnetoresistance, sensors based on giant magnetoimpedance or Hall effect sensors.

The first and second magnetic inductor 120, 130, according to this first embodiment, are both wire inductors each allowing a circular magnetic field to be generated i.e. a magnetic field which lies at every point of a circle centred around the wire oriented tangentially to this same circle. The first and second magnetic inductor 120, 130 are substantially identical. The first and second magnetic inductor 120, 130 are arranged either side of the magnetic field sensor 110 in symmetry with the detection axis 111.

With such a configuration, when the current supply system applies identical first and second currents I1, I2 to the first and second magnetic inductors 120, 130, the first and second magnetic fields at the magnetic field sensor 110 are oriented along the detection axis in opposite directions to each other. Therefore, the first and second magnetic inductor 120, 130 being substantially identical and the first and second currents I1, I2 applied thereto also being identical, the amplitudes of the magnetic fields induced by the first and second inductor 120, 130 at the magnetic sensor 111 are equal. It follows that the sum of the first and second magnetic fields B1+B2 at the magnetic sensor is substantially zero.

In addition, outside the area contained between the first and second inductors, the magnetic fields generated by the first and second magnetic inductor 120, 130 are oriented along the same direction and their amplitudes add together. Therefore, with a measurement zone 210 at which the induced magnetic fields are directed along the detection axis 111, as is the case in FIG. 2, it is possible to obtain optimized measurement by eddy currents, for this measurement zone 210, that is easy to analyse.

It will nonetheless be noted that for such a configuration in which the first and second magnetic inductor 120, 130 are substantially identical and for which the first and second current I1, I2 are identical, the sample to be measured may perturb offsetting of the first magnetic field B1 by the second magnetic field B2. On account of its metallic nature, the electromagnetic interaction between the sample and each of the first and second inductors 120, 130 differs (insofar as the airgaps differ) and differently perturb the first and second magnetic fields B1, B2 and hence the offsetting of the latter at the magnetic field sensor 110.

Therefore, according to one possibility of this first embodiment, there can also be provided an additional sub-step for modifying the second periodic current so as to cancel the sum of the first and second magnetic field B1+B2 at the magnetic field sensor 110 after positioning of the sample.

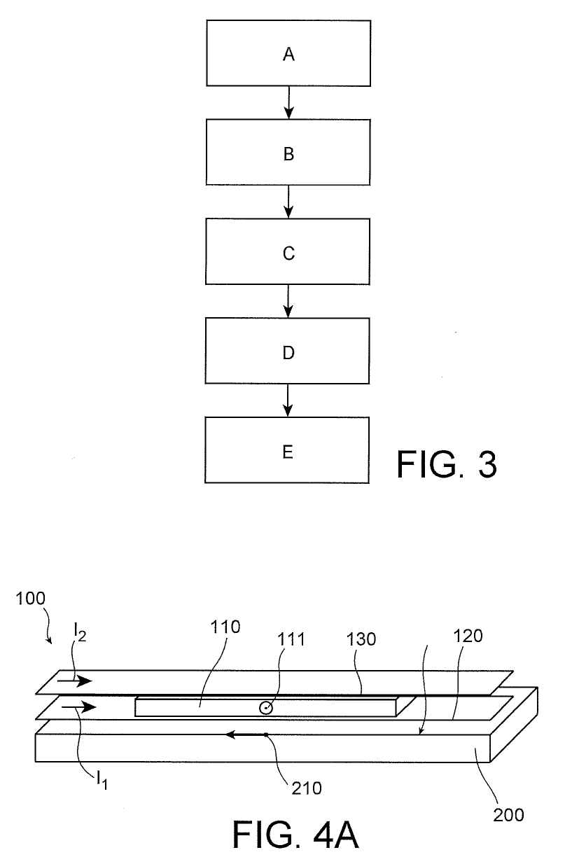

Such a measuring device 100 allows implementation of a method for measuring by eddy currents comprising, with reference to the flowchart in FIG. 3, the following steps:

A) providing the magnetic field sensor 110,

B) providing the first magnetic inductor 120 configured to generate under a given current condition a first magnetic field B1 which, at the magnetic field sensor 110 is oriented along a first direction of the detection axis 111, and at the measurement zone 210 is oriented along a second direction of the detection axis 111 opposite the first direction of the detection axis 111,

C) providing the second magnetic inductor 130 configured to generate, under the same given current condition as for the first magnetic inductor 120, a second magnetic field B2 at the magnetic field sensor 110 which at the magnetic field sensor 110 and at the measurement zone 210 is oriented along the second direction of the detection axis 111,

D) providing a current supply system 140 to apply to the first magnetic inductor 120 and to the second magnetic inductor 130 the first and second periodic current I1, I2 respectively, having the given period,

E) modifying the configuration of the first and second magnetic inductor 120, 130 in relation to the magnetic field sensor 110 and to the current supply system 140 so that on application of the first and second current I1, I2 the sum of the first and second magnetic field B1+B2 at the magnetic field sensor 110 is substantially zero, this modification being obtained in this first embodiment by modifying the relative positioning of the second magnetic inductor 130 so that it is positioned symmetrically with the first magnetic inductor 120 relative to the detection axis 111,

F) non-destructive measurement by eddy currents of the given sample 200, the sample 200 being positioned so that the measurement zone 210 comprises at least one surface portion 201 of said sample 200, the configuration of the first and second magnetic inductor 120, 130 modified at step E), i.e. their symmetrical positioning relative to the detection axis, being maintained throughout measurement.

It will be noted that in this first embodiment step E) comprises the following sub-steps:

E1) configuring the current supply system 140 so that the first and second periodic current are substantially identical,

E2) positioning the second magnetic inductor 130 symmetrically with the first magnetic inductor 120 relative to the detection axis I 111.

In addition, depending on whether a possible additional sub-step is provided to modify the second periodic current I2, step E) further comprises the following sub-steps:

E3) positioning the sample 200 with at least one surface portion 201 merging with the measurement zone 210,

E4) modifying the second periodic current I2 so as to cancel the sum of the first and second magnetic field B1+B2 at the magnetic field sensor 110.

The modification of the second periodic current I2 may entail the modification of at least one of the parameters of the second periodic current I2 from among amplitude and phase-shift relative to the first periodic current I1. Evidently, if this adjustment preferably relates to current, it can also be envisaged without departing from the scope of the invention that the current supply system is configured to modify the voltage applied to the second magnetic inductor 130 to adjust the second periodic current I2 passing through it.

Evidently, as a variant of such a step E4) it can also be envisaged without departing from the scope of the invention, to provide for modification of the first periodic current I1, the characteristics of the second periodic current I2 then remaining unchanged.

According to another variant of the invention, it can also be envisaged that step E) for mofifying the configuration of the first and second magnetic inductor 120, 130 in relation to the magnetic field sensor 110 and to the current supply system 140 is performed solely by modification of the second periodic current I2. According to this variant of the invention, step E) solely comprises the sub-steps E3) and E4).

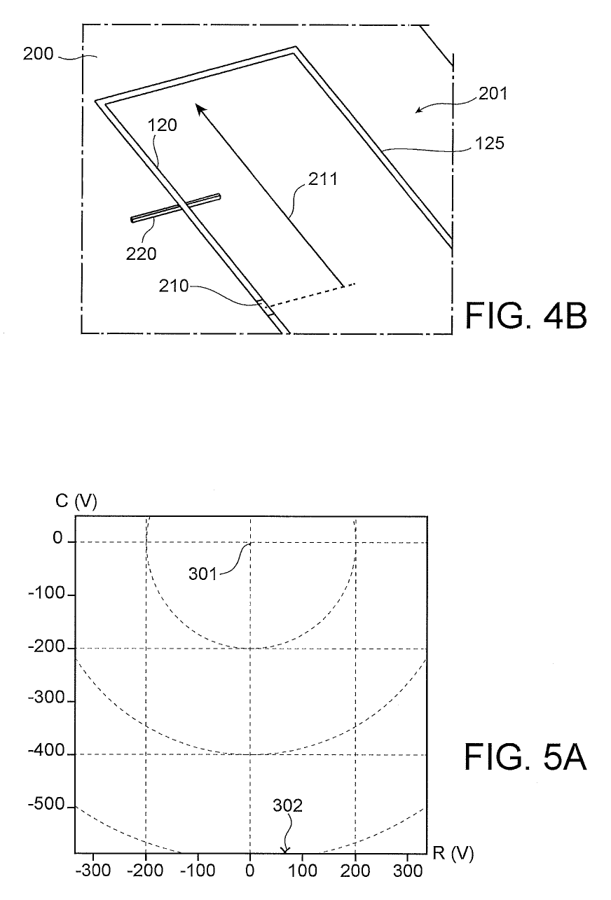

With this step E) for modifying the configuration of the first and second magnetic inductor 120, 130, whether according to the first embodiment or the variants of the invention, it is possible to perform measurement by eddy currents having increased sensitivity with such a measuring method. FIGS. 4A a 5B illustrate such a increased sensitivity with a second embodiment of the invention in which the first and second magnetic inductor 120, 130 are each in ribbon form.

A measuring device 100 according to this second embodiment differs from the first embodiment through the form of each of the first and second magnetic inductors 120, 130, these being provided in ribbons in lieu and stead of wires.

Therefore, as illustrated in FIG. 4A showing the arrangement of the first and second magnetic inductors and of the magnetic field sensor in relation to the sample, each of the first and second magnetic inductors 120, 130 is in the form of a ribbon of width 0.57 mm and thickness of 10 μm, and comprising 6 copper wire turns.

In similar manner to the first embodiment, the magnetic field sensor 110 is arranged between the first and second magnetic inductor 120, 130. The magnetic field sensor 110 is formed of a coil etched on a flexible film and having its detection axis 111, contained in the plane along which the ribbons extend forming the first and second magnetic inductor 120, 130, perpendicular to the direction of the first and second current I1, I2. This coil forming the magnetic field sensor 110 is a rectangular coil (wound in the thickness of the Kapton film) and is 0.6 mm in width, 2 mm in depth and 0.08 mm thick.

With such an arrangement of the magnetic field sensor, the first and second magnetic fields B1, B2, at the magnetic field sensor 110, lie along a first and second direction respectively of the detection axis 111.

The sample 200 is arranged facing the first magnetic inductor 120 opposite the second magnetic inductor 130 with a sample surface 201 extending parallel to the plane along which the first and second magnetic inductors 120, 130 extend.

FIG. 4B more specifically illustrates the configuration of the first magnetic inductor 120 relative to the surface 201 of the sample 200. It will be seen that this FIG. 4B illustrates the connective wiring 125 of the first magnetic inductor 120. This configuration of the first magnetic inductor 120 was also used for simulation of magnetic field by the eddy currents measured by magnetic field sensor 110 for the configuration in this second embodiment and for a prior art configuration in which no second magnetic inductor 130 is provided. It can therefore be seen in this FIG. 4B that a surface defect 220 of the sample has been positioned facing the first magnetic inductor 120. This FIG. 4B also shows the positioning of the measurement zone 210 perpendicular to which the magnetic field sensor 110 is arranged and the direction 211 in which the sensor is moved for these simulations to measure the variation in magnetic field generated by the eddy currents.

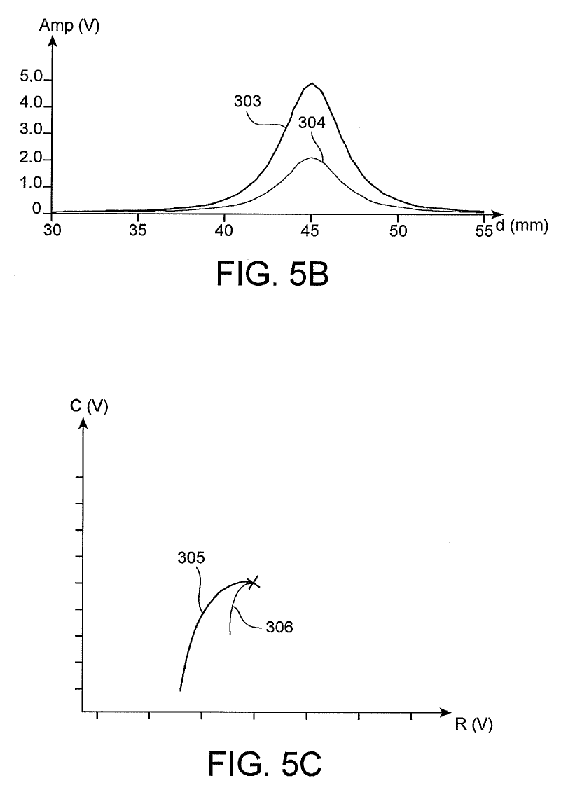

The magnetic field measured with such a configuration was simulated using CIVA® software for a device according to the first embodiment therefore comprising a second magnetic inductor 130, and a prior art device not comprising a second magnetic inductor 130, respectively. FIGS. 5A to 5C show the results of such a simulation.

For these simulations, the measuring conditions were the following:
the first periodic current I1, shows an amplitude of 100 mA for a frequency of 100 kHz,
the second periodic current I2 shows an amplitude of 150 mA and a frequency of 100 kHz, and is phase shifted by 345° relative to the first periodic current I1,
the surface of the sample is positioned 80 μm away from the first inductor,
the first and second magnetic inductors 120, 130 are each placed at a distance of 55 μm from the magnetic field sensor.

Therefore, FIG. 5A shows the result of measurement in the complex plane obtained by the magnetic field sensor 110 after being moved in direction 211 illustrated in FIG. 4B, for the configuration referenced 301 of this second embodiment and for the prior art configuration referenced 302.

It can therefore be seen in FIG. 5A that step E) for modifying the configuration of the first and second magnetic inductors 120, 130 in relation to the magnetic field sensor 110 and to the current supply system 140, for measurement 301 according to the invention allows a measurement to be obtained which remains around the origin. For measurement according to the prior art 302, since the magnetic field sensor 110 is subjected both to the magnetic field generated by the first magnetic inductor 120 and those generated by the eddy currents, measurement shows that even at a distance away from the defect 220, the magnetic field measured by the magnetic field sensor is relatively strong. In this prior art configuration, amplification of the measured magnetic field is limited by saturation of the amplifier on account of the strong magnetic field produced by the first inductor. In the measuring configuration 301 of the invention, only the magnetic field created by perturbation of eddy currents in the presence of a defect is amplified. The field variation due to perturbation of the eddy currents, weaker than the field created by the first magnetic inductor 120, can be much greater amplified. Measurement sensitivity after amplification 301 for the same defect is thereby markedly improved compared with prior art measurement.

FIGS. 5B and 5C illustrate another advantage of the configuration of the invention. FIG. 5B illustrates the simulated variation in the magnetic field 303 for the configuration of the invention in which the second magnetic inductor 130 is provided, and the simulated variation 304 for the prior art configuration in which no second inductor is provided, when the magnetic field sensor is moved along direction 211. It can be seen that there is a major increase in amplitude, since a signal gain of 7.3 dB is obtained. Since the amplification conditions are identical for these two simulations, this gain is solely related to the addition, at the measurement zone, of the magnetic fields generated by the first and second magnetic inductors 120, 130.

This phenomenon is also illustrated in FIG. 5C which shows the variations 305, 306 in the complex plane of the magnetic field measured by the magnetic field sensor 110 for the configuration of the invention 305 and for the prior art configuration 306 respectively, when the magnetic field sensor 110 is moved along direction 211. Only the variations related to the presence of the defect being shown in FIG. 5C, the two signals 305, 306 representing these variations start at the origin of the axes. It can therefore be seen in this FIG. 5C, that the variation 305 observed for the configuration of the invention is much greater than that 306 observed for the prior art configuration.

Therefore, the measuring method of the invention benefits from the accumulated gain obtained through the low, even non-existent influence of the first magnetic inductor 120 on the magnetic field sensor 110, thereby allowing optimized amplification without degrading the sensitivity of the magnetic field sensor 110, and through the addition of the magnetic fields induced by the first and second magnetic inductor 120, 130 at the measurement zone 210. Therefore, the measuring method of the invention allows increased variation in the magnetic field produced by the eddy currents, and the amplification thereof. The signal (i.e. the variation in the magnetic field produced by the eddy currents, largely amplified) to noise ratio is thereby improved.

It can be noted that while in the first and second embodiments described above, the modification at E) of the configuration of the first and second magnetic inductor 120, 130 is chiefly obtained through modification of the relative positioning of the second magnetic inductor 130 in relation to the first magnetic inductor 120, it is also possible to obtain such a modification otherwise.

Therefore, as a variant or in addition, step E) may comprise the following sub-steps:

E′1) configuring the current supply system to apply the first and second current I1, I2 to the first and second magnetic inductor 120, 130 respectively,

E′2) modifying the positioning of the second magnetic inductor 130 in relation to the first magnetic inductor 120 and to the detection axis 120, such that the sum of the first and second magnetic field B1+B2 at the magnetic field sensor 110 is substantially zero.

It can be noted that these sub-steps E1) and E′2) can be implemented in the absence of a sample 200, to obtain a configuration that can be used on any sample and allows limiting of the influence of the magnetic field of the first magnetic inductor 120 without full elimination thereof on account of an “airgap” effect caused by the presence of a sample. They can also be implemented in the presence of a sample 200 to take this “airgap” effect into consideration. According to this second possibility, it can be envisaged to perform the step for modifying the configuration of the first and second magnetic inductor in two stages. At a first stage in the absence of the sample, for example by implementing the sub-steps E1) to E2) described with reference to the first embodiment of the invention, At the second stage after placing the sample in position by implementing the sub-steps E′1) and E′2) for example.

Evidently, the measuring device 100 in this variant of the invention, to enable such a modification of configuration, has a second magnetic inductor 130 that is movably mounted relative to the first inductor 120.

As a variant, step E) may comprise the following sub-steps:
E″1) configuring the current supply system 140 to apply the first and second periodic current,
E″2) modifying the positioning of the magnetic field sensor 110 in relation to the first and second magnetic inductor 120, 130 so as to cancel the sum of the first and second magnetic field B1, B2 at the magnetic field sensor 110.

Similar to the preceding variant of the invention, the measuring device 100 of this variant of the invention, to enable such a modification of configuration, has a magnetic field sensor 110 that is movably mounted relative to the first magnetic inductor 120.

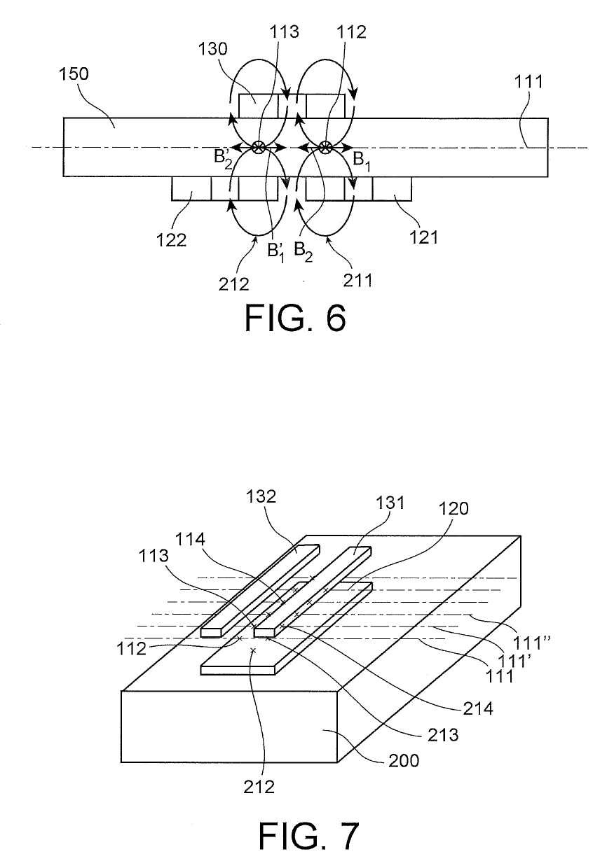

FIG. 6 illustrates a measuring device 100 according to a third embodiment in which there are provided two first magnetic inductors 121, 122 and only one second magnetic inductor 130, each of these three magnetic inductors 121, 122, 130 being provided as a respective flat coil formed on one of the sides of a flexible dielectric support. A measuring device 100 according to this second embodiment differs from a measuring device 100 according to the first embodiment in that two first magnetic inductors 121, 122 are provided each formed by a respective flat coil, in that the second magnetic inductor is also provided as a flat coil, and in that two magnetic field sensors 112, 113 are provided.

It can also be envisaged, without departing from the scope of the invention, to provide for more than two magnetic field sensors regularly arranged at equal distances, in the continuity of the first two by adding the necessary inductors (first and/or second inductor). It can therefore be seen in FIG. 6 that the two first magnetic inductors 121, 122 are each obtained by forming a respective flat coil on a first side of the dielectric support and that the second magnetic inductor 130 is obtained by forming a flat coil on a second side of the flexible dielectric support. Such a forming on a flexible dielectric support, such as a flexible printed circuit formed either in polyimide or in PEEK film, allows a measuring device to be obtained the shape of which can adapt to the surface curvature of the sample to be measured.

Evidently, as a variant, the support can be rigid or semi-rigid without departing from the scope of the invention, and hence can be formed for example in an epoxy resin such as an epoxy resin of FR-4 type (Flame Resistant-4).

The coil forming the second magnetic inductor 120 is placed between the two coils respectively forming the first and second magnetic inductor 121, 122. In this manner it is possible with the second magnetic inductor 130, and at each of the magnetic field sensors 100, to offset the magnetic field induced by the first and second magnetic inductor 121, 122.

The magnetic field sensors 112, 113 are included in the flexible dielectric support and have their detection axes 111 lying along the plane of the flexible dielectric support 150. The use of two magnetic field sensors 112, 113, as illustrated in FIG. 6, makes it possible to perform measurement by eddy currents at two measurement zones 212, 213 simultaneously.

With such an arrangement of the magnetic field sensors 112, 113 included in a flexible dielectric support, the modification of the configuration of the two first magnetic inductors 121, 122 and of the second magnetic inductor 130 can be performed by modifying the current supply system, in particular the current supplying the second magnetic inductor 130.

FIG. 7 illustrates a configuration of a device for measuring by eddy currents 100 according to a fourth embodiment in which there is provided a first magnetic inductor 120, two second magnetic inductors 131, 132 and a plurality of magnetic field sensors 112, 113, 114. A measuring device 100 according to this fourth embodiment differs from a measuring device according to the first embodiment in that there are provided two second magnetic inductors 131, 132 and a plurality of magnetic field sensors 112, 113, 114.

The two second magnetic inductors 131, 132 extend parallel to the first magnetic inductor 120 and symmetrically with each other relative to a plane containing the first inductor and the field sensors 112, 113, 114.

The magnetic field sensors 112, 113, 114 are arranged between the first and second magnetic inductors 120, 131, 132 aligned in a direction parallel to the first magnetic inductor 120. The detection axes 111, 111′, 111″ of the magnetic field sensors are parallel to each other and substantially perpendicular to the first and to the two second magnetic inductors.

With such an arrangement of the device for measuring by eddy currents 100, the positioning of the two second magnetic inductors 131 gives access to the magnetic field sensors 112, 113, 114. Therefore, the modification of the configuration of the first magnetic inductor 120 and of the two second magnetic inductors 131, 132, can be obtained by modifying the relative positioning of the magnetic field sensors 112, 113, 114 in relation to the first and to the two second magnetic inductors 120, 131, 132. It can be seen in FIG. 7 that it is possible to perform measurement by eddy currents at measurement zones 212, 213, 214 extending along the first magnetic inductor 120.

With such a measuring device, on account of the plurality of magnetic field sensors 112, 113, 114, measurement by eddy currents can be performed simply by lateral movement of the set of magnetic field sensors 112, 113, 114 and of the first and two second magnetic inductors 120, 131, 132.

Therefore, as shown in this third and fourth embodiment, while in the above-described first and second embodiments there is provided only one first inductor, only one second inductor and only one magnetic field sensor, other configurations can also be envisaged without departing from the scope of the invention.

Similarly, it can also be envisaged, without departing from the scope of the invention, to provide a configuration such as those defined in the first and second embodiments, a multiple number of sets of magnetic field sensors and sets of first and second magnetic inductors, each of the sets reproducing the configuration of said first or second embodiment. It is therefore possible to align each of these sets at equal distance so as to define a measuring line similar to the one described above with reference to the fourth embodiment.

1-15. (canceled)

16. A method for measuring by eddy currents comprising:
a) providing at least one magnetic field sensor having a detection axis along which the magnetic field sensor is sensitive to magnetic fields;
b) providing at least one first magnetic inductor configured and arranged to generate under a given current condition a first magnetic field which, at the magnetic field sensor, is oriented along a first direction of the detection axis, and at a measurement zone is oriented along a second direction of the detection axis opposite the first direction of the detection axis;
c) providing at least one second magnetic inductor configured and arranged to generate, under same given current conditions as for the first magnetic inductor, a second magnetic field which at the magnetic field sensor and at the measurement zone is oriented along the second direction of the detection axis;
d) providing a current supply system to apply to the first magnetic inductor a first periodic current having a given period, and to apply to the second magnetic inductor a second periodic current having the given period;
e) modifying configuration of the first and second magnetic inductors in relation to the magnetic field sensor and/or to the current supply system so that, on application of the first and second current, the sum of the first and second magnetic fields at the magnetic field sensor is substantially zero; and
f) non-destructive measuring by eddy currents a given sample, the sample being positioned so that the measurement zone comprises at least one surface portion of the sample, the configuration of the first and second magnetic inductor modified at e) being maintained throughout measurement.

17. The measuring method according to claim 16, wherein the e) modifying the configuration of the first and second magnetic inductors is performed at least partly in absence of a sample.

18. The measuring method according to claim 16, wherein the e) modifying the configuration of the first and second magnetic inductors is performed at least partly in presence of the sample, the sample being positioned so that the measurement zone comprises at least one surface portion of the sample, the measurement zone remaining on a surface of the sample when f) is implemented.

19. The measuring method according to claim 16, wherein at c) for providing the second magnetic inductor, the second magnetic inductor is substantially identical to the first magnetic inductor.

20. The measuring method according to claim 16, wherein the e) modifying the configuration of the first and second magnetic inductors comprises:
e1) configuring the current supply system so that the first and second periodic currents are substantially identical;
e2) modifying relative positioning of the second magnetic inductor so that it is positioned symmetrically with the first magnetic inductor relative to the detection axis.

21. The measuring method according to claim 16, wherein the e) modifying the configuration of the first and second magnetic inductors comprises:
e′1) configuring the current supply system to apply the first and the second periodic currents;
e′2) moving the second magnetic inductor to cancel the sum of the first and second magnetic fields at the magnetic field sensor.

22. The measuring method according to claim 16, wherein the e) modifying the configuration of the first and second magnetic inductors comprises:
e″1) configuring the current supply system to apply the first and the second periodic currents;
e″2) moving the magnetic field sensor in relation to the first and second magnetic inductors to cancel the sum of the first and second magnetic fields at the magnetic field sensor.

23. The measuring method according to claim 16 wherein the e) modifying the configuration of the first and second magnetic inductors comprises:
e3) configuring the current supply system to apply the first and second periodic currents;
e4) modifying the second periodic current so as to cancel the sum of the first and second magnetic fields at the magnetic field sensor.

24. A device for measuring by eddy currents, comprising:
at least one magnetic field sensor having a detection axis along which the magnetic field sensor is sensitive to magnetic fields;
at least one first magnetic inductor configured and arranged to generate under a given current condition a first magnetic field which, at the magnetic field sensor is oriented along a first direction of the detection axis, and at a measurement zone is oriented along a second direction of the detection axis opposite the first direction of the detection axis;
at least one second magnetic inductor configured and arranged to generate, under same current conditions as for the first magnetic inductor, a second magnetic field which at the magnetic field sensor and at a measurement zone is oriented along the second direction of the detection axis;
at least one current supply system to apply to the first a first periodic current having a given period and to apply to the second magnetic inductor a second periodic current having the given period; and
wherein the first and second magnetic inductor have at least one configuration in relation to the magnetic field sensor and to the current supply system so that, on application of the first and second currents, the sum of the magnetic field respectively induced by the first and second magnetic inductors at the magnetic field sensor is substantially zero.

25. The measuring device according to claim 24, wherein the first and second magnetic inductors are substantially identical.

26. The measuring device according to claim 24, wherein the current supply system is configured to supply the first and second inductors with a first and second substantially identical current.

27. The measuring device according to claim 25, wherein the second magnetic inductor is movably mounted in relation to the first magnetic inductor and to the magnetic field sensor.

28. The measuring device according to claim 25, wherein the magnetic field sensor is movably mounted in relation to the first and to the second magnetic inductors.

29. The measuring device according to claim 25, wherein the current supply system is configured to apply a second periodic current to the second magnetic inductor differing from the first periodic current to allow the configuration of the first and second magnetic inductors to be obtained in relation to the magnetic field sensor and to the current supply system in which, on application of the first and second periodic currents, the sum of the magnetic field respectively induced by the first and second magnetic inductors at the magnetic field sensor is substantially zero.

30. The measuring device according to claim 25, wherein the first and second magnetic inductors are respectively provided by a first and second coil respectively formed on the first and second sides of a dielectric support,
and wherein the magnetic field sensor is included in the dielectric support.
